(19) United States
(12) Patent Application Publication
(10) Pub. No.: US 2005/0169460 A1
(43) Pub. Date: Aug. 4, 2005

(54) Portable electronic apparatus

(76) Inventor: Ying-Shi Lin, Banqiao City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/979,564

(22) Filed: Nov. 2, 2004

(30) Foreign Application Priority Data
Jan. 30, 2004 (TW) 93201369

(51) Int. Cl. H04M 1/00; H04M 9/00

(52) U.S. Cl. 379/433.07

(57) ABSTRACT

A portable electronic apparatus. The portable electronic apparatus has a main body with a plurality of keys disposed thereon. The main body is bisected by a first axis, and the keys are bisected by a second axis. The first and second axes intercept with each other by a predetermined angle.

### BACKGROUND OF THE INVENTION

1. Field of the Invention

The present invention relates in general to a portable electronic apparatus and in particular to a portable electronic apparatus with angled keypad.

2. Description of the Related Art

Referring to FIG. 1, the conventional portable electronic apparatus, such as a mobile phone, comprises a main body M with a display 10 and a keypad 20 disposed thereon. A first longitudinal axis C passes through the center of the main body M. A plurality of keys 201 are disposed in the keypad 20 for data input. Generally, the keypad 20 is arranged centrally on the main body M in alignment with the first axis C as shown in FIG. 1.

### SUMMARY OF THE INVENTION

Accordingly, an object of the present invention is to provide a portable electronic apparatus with an angled keypad. The portable electronic apparatus has a main body with a keypad disposed thereon. The main body is bisected by a first axis, and the keypad is bisected by a second axis. The first and second axes intercept with each other by a predetermined angle. Thus, a more convenient angle use is provided irrespective of a user's right- or left-handedness.

### DESCRIPTION OF THE DRAWINGS

The present invention will become more fully understood from the detailed description given hereinbelow and the accompanying drawings, given by way of illustration only and thus not intended to be limitative of the present invention.

FIG. 1 is a perspective diagram of a conventional portable electronic apparatus.

FIG. 2 is a perspective diagram of the first embodiment in accordance with the present invention.

FIG. 3 is a perspective diagram of the second embodiment in accordance with the present invention.

### DETAILED DESCRIPTION OF THE INVENTION

### First Embodiment

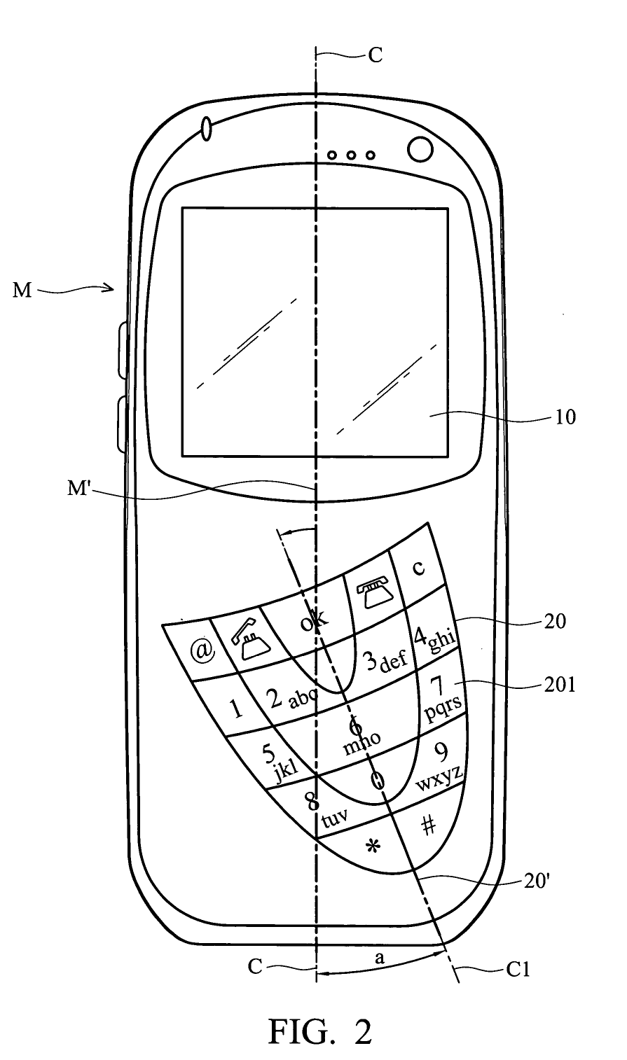

Referring to FIG. 2, the portable electronic apparatus in this embodiment is a mobile phone comprising a main body M with a display 10 and a keypad 20 disposed thereon. The main body M has a first longitudinal axis M′ extending along a first axis C. The first axis C passes through the main body M, and the display 10 is equally divided by the first axis C.

As shown in FIG. 2, the keypad 20 comprises a plurality of keys 201 for data input, and a second longitudinal axis 20′ of the keypad 20 extends along a second axis C1. In this embodiment, the keypad 20 is approximately half-ellipse-shaped and bisected by the second axis C1 passing through the center thereof.

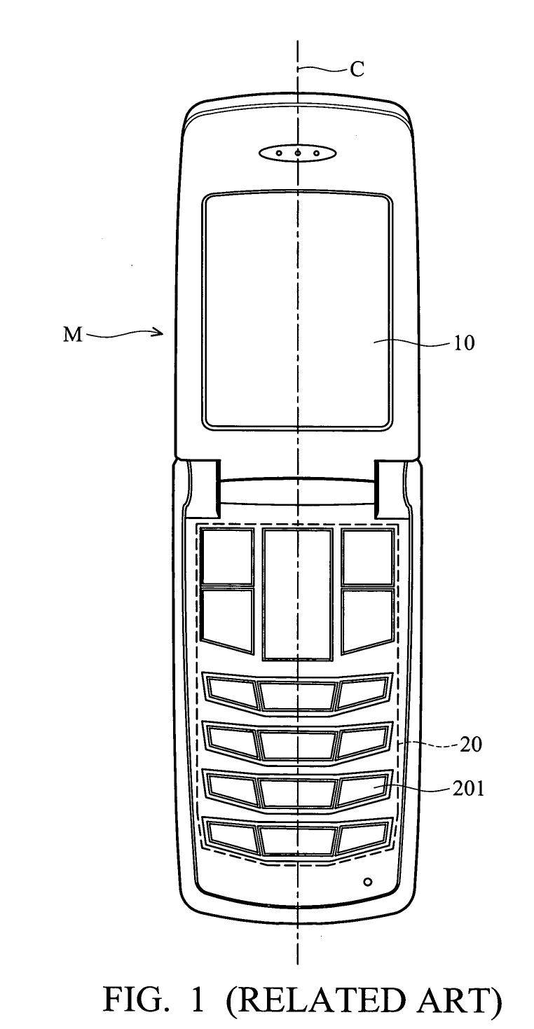

The keypad 20, however, can be rectangular (as shown in FIG. 1) or any other shape. As shown in FIG. 2, the first and second axes C and C1 intercept with each other by a predetermined angle a, wherein 25°<a<35°. As the arrow indicates in FIG. 2, the second axis C1 and, correspondingly, the keys 201 are canted leftward such that right-handed use is more convenient.

### Second Embodiment

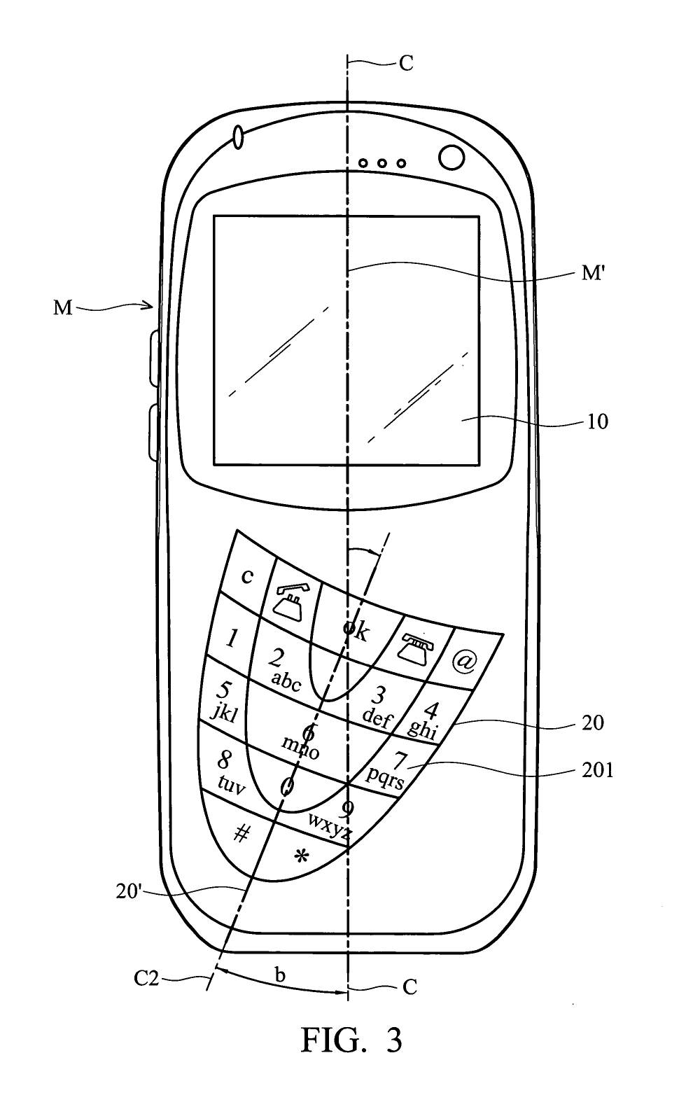

Referring to FIG. 3, the portable electronic apparatus comprises a main body M with a display 10 and a keypad 20 disposed thereon. The main body M has a first longitudinal axis M′ extending along a first axis C. As mentioned, the first axis C passes through the main body M, and the display 10 is equally divided by the first axis C. A plurality of keys 201 are disposed in the keypad 20 for data input.

In this embodiment, a second longitudinal axis 20′ of the keypad 20 extends along a second axis C1. The keypad 20 is approximately half-ellipse-shaped and bisected by the second axis C2 passing through the center thereof. The keypad 20, however, can be rectangular (as shown in FIG. 1) or any other shape. As shown in FIG. 3, the first and second axes C and C1 intercept with each other by a predetermined angle a, wherein 25°<b<35°. As the arrow indicates in FIG. 3, the second axis C2 and, correspondingly, the keys 201 are canted rightward such that a left-handed use is more convenient. In summary, the present invention provides a portable electronic apparatus such as a mobile phone providing a more convenient angle of use irrespective of a user's right- or left-handedness.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation to encompass all such modifications and similar arrangements.

1. A portable electronic apparatus, including:
a main body bisected by a first axis with a keypad comprising a plurality of keys disposed thereon, wherein the keypad is bisected by a second axis at the center thereof canted with respect to the first axis.

2. The portable electronic apparatus as claimed in claim 1, wherein the keys are canted with respect to the first axis.

3. The portable electronic apparatus as claimed in claim 1, wherein the second axis is canted leftward by a predetermined angle between 25° and 35° with respect to the first axis.

4. The portable electronic apparatus as claimed in claim 1, wherein the second axis is canted rightward by a predetermined angle between 25° and 35° with respect to the first axis.

5. A portable electronic apparatus, including:
a main body;
a display disposed on the main body and a first longitudinal axis of the display extending along a first axis; and
a keypad having a plurality of keys disposed on the main body and a second longitudinal axis of the keypad extending along a second axis, wherein the first and second axes intercept with each other by a predetermined angle.

6. The portable electronic apparatus as claimed in claim 5, wherein the second axis is canted leftward with respect to the first axis.

7. The portable electronic apparatus as claimed in claim 5, wherein the second axis is canted rightward with respect to the first axis.

8. The electronic apparatus as claimed in claim 5, wherein the predetermined angle is between 25° and 35°.

9. The electronic apparatus as claimed in claim 5, wherein the display is bisected by the first axis.

10. The electronic apparatus as claimed in claim 5, wherein the keypad is bisected by the second axis.

11. A portable electronic apparatus, including:
a main body having a first longitudinal axis extending along a first axis; and
a keypad having a plurality of keys disposed on the main body and a second longitudinal axis of the keypad extending along a second axis, wherein the first and the second axes intercept with each other by a predetermined angle.

12. The portable electronic apparatus as claimed in claim 11, wherein the second axis is canted rightward with respect to the first axis.

13. The portable electronic apparatus as claimed in claim 11, wherein the second axis is canted leftward with respect to the first axis.

14. The electronic apparatus as claimed in claim 11, wherein the predetermined angle is between 25° and 35°.

15. The electronic apparatus as claimed in claim 11, wherein the main body is bisected by the first axis.

16. The electronic apparatus as claimed in claim 11, wherein the keypad is bisected by the second axis.
